(19) United States
(12) Patent Application Publication
(10) Pub. No.: US 2018/0122277 A1
(43) Pub. Date: May 3, 2018

(54) Illuminated Ink Letter Showcase

(71) Applicants: Avner Harel, New York, NY (US); Moshe Schneider, Boynton Beach, FL (US)

(72) Inventors: Avner Harel, New York, NY (US); Moshe Schneider, Boynton Beach, FL (US)

(21) Appl. No.: 15/853,901

(22) Filed: Dec. 25, 2017

Related U.S. Application Data
(63) Continuation of application No. 14/985,611, filed on Dec. 31, 2015.

(51) Int. Cl. G09F 13/02; A47G 1/06

(52) U.S. Cl. CPC G09F 13/02; A47G 2001/0688; A47G 1/06

(57) ABSTRACT

Embodiments of the disclosed technology relate to a document with printed ink or other ink displayed on the document. A frame is used to display the document, having lights on a translucent surface, the frame corresponding to an outline of the ink. These lights are fixed or movable with respect to the surface. in order to align them to the character on the paper to be highlighted in outlined lights. The frame, in embodiments, has an opening such that one inserts the paper there-through until it hits the other side which aligns indicia on the document with the lights on the surface of the frame in outline form.

### FIELD OF THE DISCLOSED TECHNOLOGY

The disclosed technology relates generally to frames, and more specifically, to illuminated frames.

### BACKGROUND OF THE DISCLOSED TECHNOLOGY

Frames to protect, add beauty to, and show documents and art are known. A graduate might frame his diploma, a business might frame its operating license, and a restaurant might frame a government rating, a rating from a commercial agency, or even a certificate attesting to the kashrus of the establishment. In some cases, however, establishments might wish to hide such documents. For example, when receiving a low health grade the corresponding certificate will be displayed less prominently or hidden from view, despite required government regulations concerning such display.

Further, illuminated frames are known. One simply adds a light, typically at the bottom edge, which lights up the frame or item displayed in the frame. Others provide back-lighting, with light passing through the item displayed in the frame. Examples include U.S. Pat. Nos. 5,010,672 and 3,997,991, as well as U.S. Patent Publication 2003/01003345.

What is needed in the art is a way to better illuminate framed items for display, so as to more specifically illuminate salient parts rather than blanket-illuminating the entire item or illuminating from just one side. Targeted illumination would better aid in emphasizing what is desired to be pointed out to the viewer.

### SUMMARY OF THE DISCLOSED TECHNOLOGY

The disclosed technology includes a frame which highlights ink there-beneath, with lights positioned on the outline (including just outside the outline, that is, within 1 cm) or extremities of the ink. This is accomplished by having a translucent surface, a spaced-apart region between a side opposite the translucent surface and the translucent surface, and a plurality of lights on the translucent surface, each corresponding to a position of an outline of a character. A document with the character is placed within the spaced apart region, such that an outline of the character on the document is aligned with the plurality of lights on said translucent surface. An additional character can be represented by a different set of a plurality of lights on the translucent surface, which corresponds to an outline of a second character printed in ink on the document.

The plurality of lights can include some or all which are movable. These lights can be fixed to an exterior side or interior side of the translucent surface. The frame can further have an opening into the spaced-apart region situated transverse to the translucent surface. A document passed through this opening completely has indicia which align with the outline of the character, in embodiments of the disclosed technology.

In another way of describing the above embodiments, a kit has paper with ink indicia and a frame. The frame, in turn, has a translucent surface with a plurality of fixed lights on a surface arranged into a shape of a character. The ink indicia are located on the paper, such that when the paper is inserted into the frame, the ink indicia are aligned with the plurality of fixed lights, such that each light of the plurality thereof corresponds to a position of an extremity of the ink indicia/character. The plurality of fixed lights can form a representation of the character at an outline of the ink indicia. The frame can have an opening into a spaced-apart region between the translucent side and a side opposite the translucent region (a back side). Paper placed into the opening until reaching a furthest extremity opposite the opening (e.g., a bottom side of the interior of the frame) causes the plurality of fixed lights on the surface to align with the outline of the ink indicia, in embodiments of the disclosed technology.

Similarly, when described in terms of a method, such a method proceeds to display a document as follows. First, one determines a position of a character depicted on a document when the document is inserted into the frame. Then one places a plurality of lights on a translucent surface of the frame, each corresponding to a position of an outline of the character. It stands to reason that, further, one can also carry out a step of actually placing the paper in the frame. One inserts the document there-in, such as by way of an opening on one side thereof. When completely inserted, the lights then line up with the character and/or indicia on the surface of paper.

Such lights can be fixed to the translucent surface before inserting the paper. They can also be movable with respect to the translucent surface even after the step of inserting is carried out. In embodiments, the plurality of lights ends up directly above an outline and/or extremity of a character in the document.

“Substantially” and “substantially shown,” for purposes of this specification, are defined as “at least 90%,” or as otherwise indicated. Any device may “comprise” or “consist of” the devices mentioned there-in, as limited by the claims.

It should be understood that the use of “and/or” is defined inclusively, such that the term “a and/or b” should be read to include the sets: “a and b,” “a or b,” “a,” “b.”

### BRIEF DESCRIPTION OF THE DRAWINGS

FIG. 1 shows a sign read to be inserted into a frame of embodiments of the disclosed technology.

FIG. 2 shows the sign being inserted into the frame in an embodiment of the disclosed technology.

FIG. 3 shows the sign in the frame, aligned with surface lights, in an embodiment of the disclosed technology.

FIG. 4 shows the lights of FIG. 3 illuminated around ink of the sign in an embodiment of the disclosed technology.

FIG. 5 shows a version of the devices of FIG. 4, with additional illuminated lights around the edges thereof, in an embodiment of the disclosed technology.

FIG. 6 shows a different sign inserted into a frame and aligned with lights of an embodiment of the disclosed technology.

FIG. 7 shows yet another such sign inserted into a frame and aligned with lights of an embodiment of the disclosed technology.

FIG. 8 shows yet another such sign inserted into a frame and aligned with lights of an embodiment of the disclosed technology.

### DETAILED DESCRIPTION OF EMBODIMENTS OF THE DISCLOSED TECHNOLOGY

Embodiments of the disclosed technology relate to a document with printed ink or other placed ink displayed on the document. A frame is used to display the document, having lights on a translucent surface, with the frame corresponding to an outline of the ink. These lights are fixed, or movable with respect to the surface, in order to align them to the character on the paper to be highlighted in outlined lights. The frame, in embodiments, has an opening, such that one inserts the paper there-through until it hits the other side which aligns indicia on the document with the lights on the surface of the frame in outline form.

Embodiments of the disclosed technology will become clearer in view of the following discussion of the figures.

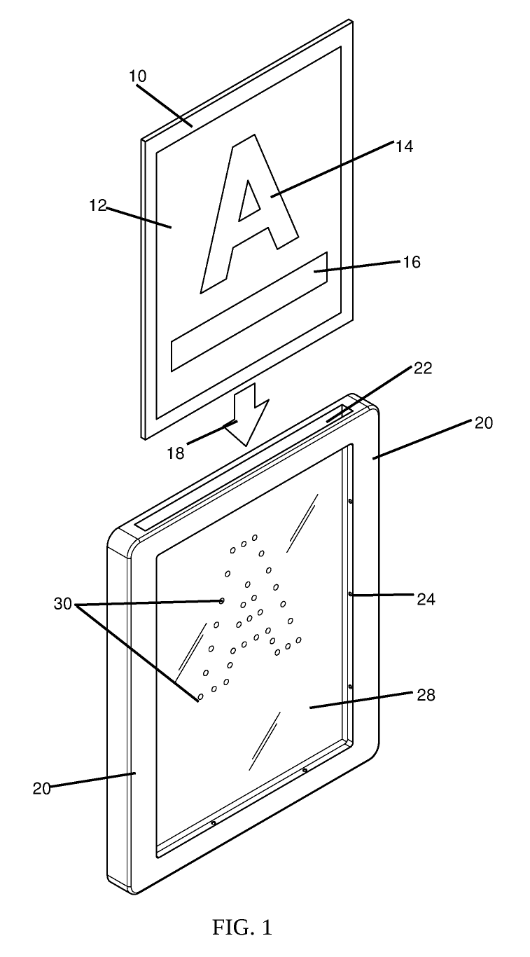

FIG. 1 shows a sign read to be inserted into a frame of embodiments of the disclosed technology. Here, the sign 10, with a front side or paper 12, has various indicia there-on. This includes, in this case, a character 14 in the form of the letter “A” printed in ink on the paper 12. Other indicia, such as wording, can also be included, as represented by box 16. The sign 10 can be any generally flat, or flat with a raised portion, item with indicia. The indicia can be a character or plurality of characters recognized as a letter, symbol, or other design with a known shared meaning among people who create, display, and/or see the signs. Thus, in this example shown in FIG. 1, the “A” has a meaning of a letter in many alphabets as well as being the highest grade one can receive from the city of New York for a sanitary grade of a restaurant.

The frame 20 has a translucent side 28 through which the sign 10/paper 12 is at least partially or fully visible, save for edges. “Edges” for purposes of this disclosure, are a portion of a sign or paper which is within 3 centimeters of a point where two sides of the sign or paper meet. Thus, one views the majority or all of one of the sign 10 and/or paper 12 through the frame 20. In an example shown, one inserts the sign 10 through a slot 22 of the frame on an upper side thereof, by pushing the sign in the direction 18, into the frame. This is but one way of inserting the sign into the frame. It should be understood that other framing mechanisms known in the art, such as attaching a backing, building a frame from its component sides and the like are within the scope of the disclosed technology. The lights 30 will be discussed in greater detail with respect to the later figures.

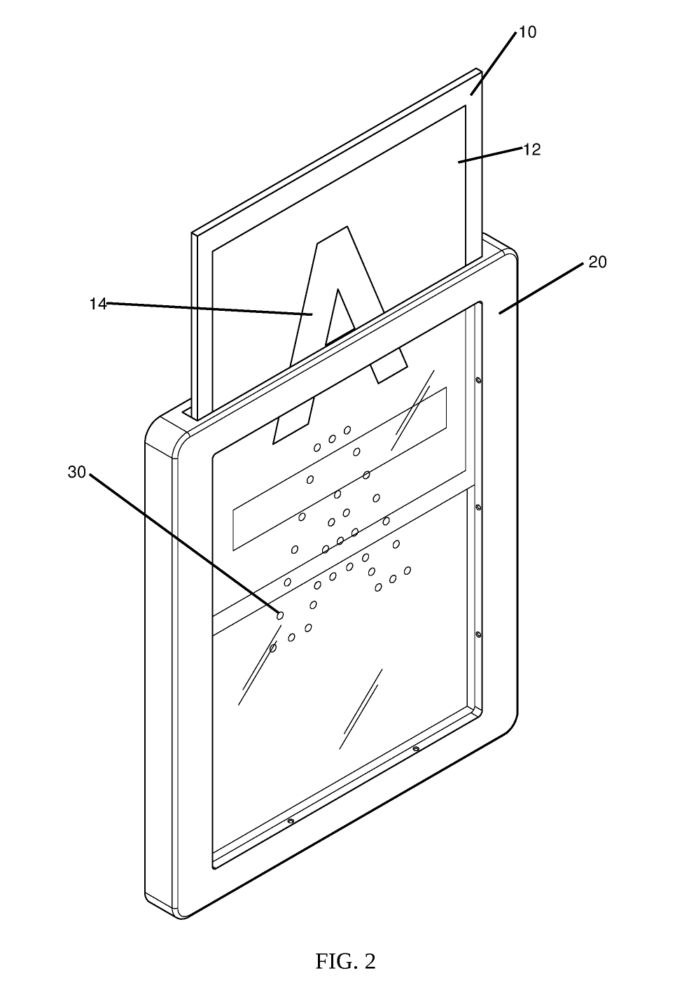

FIG. 2 shows the sign being inserted into the frame in an embodiment of the disclosed technology. Here, the sign 10 with the paper 12 is being pushed down into the frame 20. Note that the printed letter “A” (a form of indicia 14) on the paper 12, is not yet aligned with the lights 30.

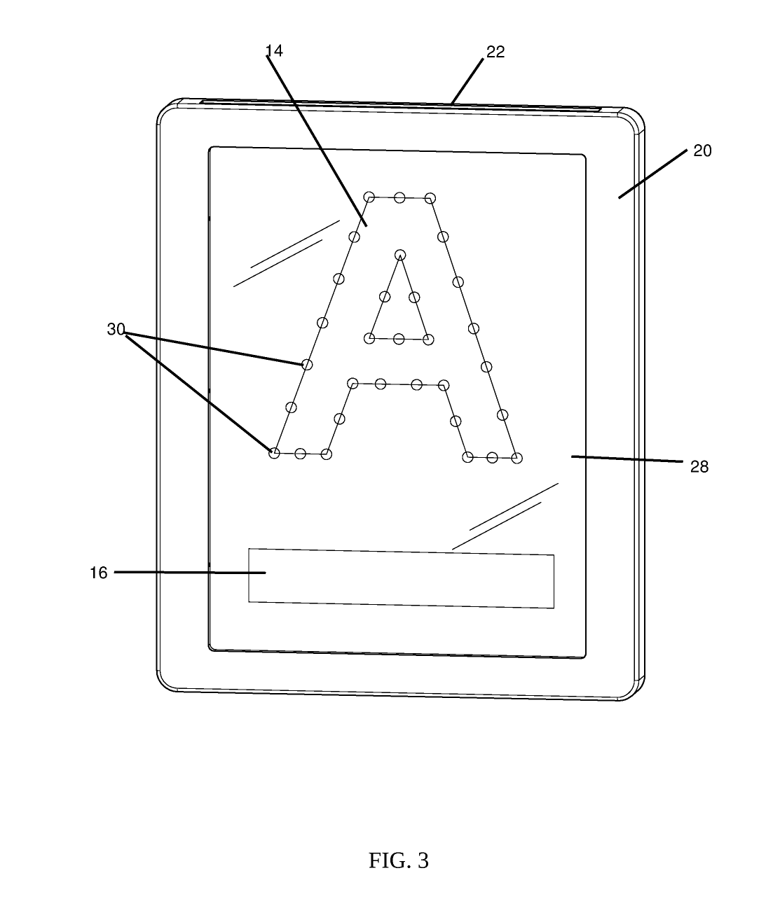

FIG. 3 shows the sign in the frame, aligned with surface lights in an embodiment of the disclosed technology. Here, the paper has been fully inserted, so that the indicia 14 are lined up with the lights 30. The lights can be any sort of device which emits light in the visible spectrum. This includes LED lights (light emitting diode) and variants thereof. Such variants include organic LED (OLED), quantum dot LED (QD) and the like. These lights 30 are placed, or pre-placed, on the translucent surface 28 of the frame 20. The lights can be individually powered by a battery beneath each light, powered by a thin wire extending from a power source in the frame 20 to the light, or be powered by an electromagnetic field passing along the surface or just under the surface 28. Further, a wire mesh network can be woven into the material forming the translucent surface 28 itself, such that a light 30 positioned anywhere there-on will receive current which illuminates the light. FIG. 1 shows an electrical connection point 24 from which a wire individually, or as part of a mesh of wires, can be powered to illuminate the lights 30.

The lights can be in a fixed position on the surface 28. “Fixed,” for purposes of this disclosure, is defined as “immovable without causing destruction or irreversible degradation in quality of the structure being moved.” In other embodiments, the lights, or some of the lights, can be movable and/or placed onto the surface 28 at various positions. “Movable,” for purposes of this disclosure, is defined as, “being fully operable in a plurality of positions along the surface, subsequent to prior full operation.” The lights can also be movable in a first instance and then fixed, such as when the lights come as part of a kit and then are attached to a particular position on the surface 28. Once attached, they become fixed in place.

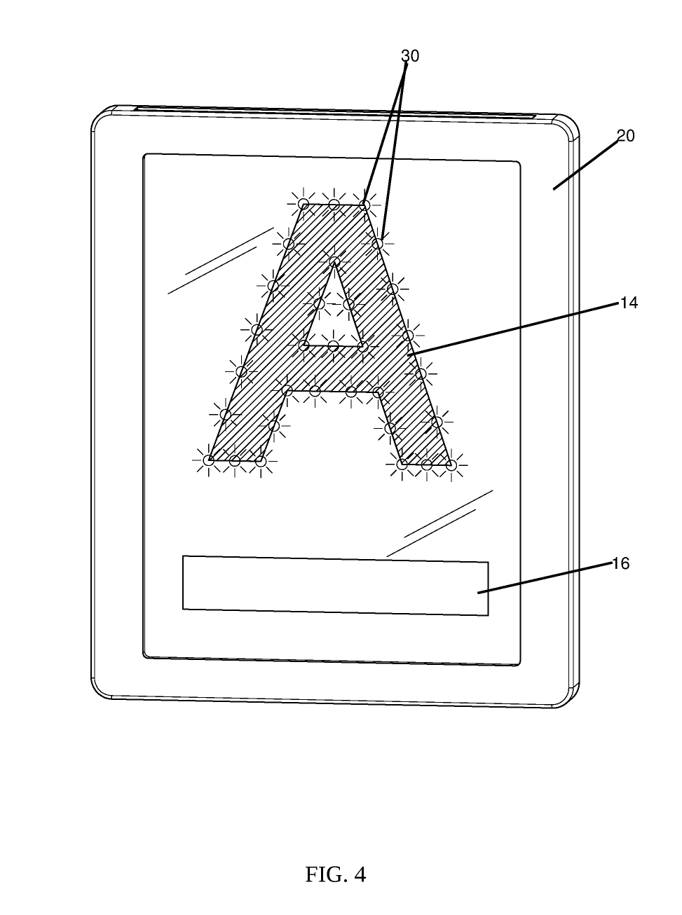

FIG. 4 shows the lights of FIG. 3 illuminated around ink of the sign. in an embodiment of the disclosed technology. Note that the indicia 14 here are a printed ink letter A on the paper. On the translucent front side 28 of the frame 20 is a plurality of lights 30 which have been aligned with the extremities of the indicia. That is, the lights 30 are in the shape of the letter “A” beneath. This is accomplished by placing the lights at spaced-apart intervals on each extremity or outline of the letter. To be more precise, the position of the letter “A” or other indicia 14 is determined relative to the translucent plate 28 directly in front of the letter. To avoid parallel problems, the letter is ideally placed as close to the translucent plate 28 as possible, and the translucent plate is as thin as possible, such as being 1 cm or less, 5 mm or less, or 2 mm or less in thickness. In embodiments, the lights 30 are placed on the outline of the letter when viewing from an angle perpendicular to the plane of the translucent surface 28 and/or front side of the frame 20 (the side most viewable in FIG. 3).

Note that the outline of the A also includes an inner space or triangle. This too forms part of the outline of the symbol. At least one light 30 is placed on each side of the outline of the letter, so as to make the character recognizable based on the lights alone. The sign, however, is still displayed in accordance with government regulations, as the information contained thereon is fully visible. The lights 30 may also be translucent so that the ink on the sign is still visible beneath each respective light.

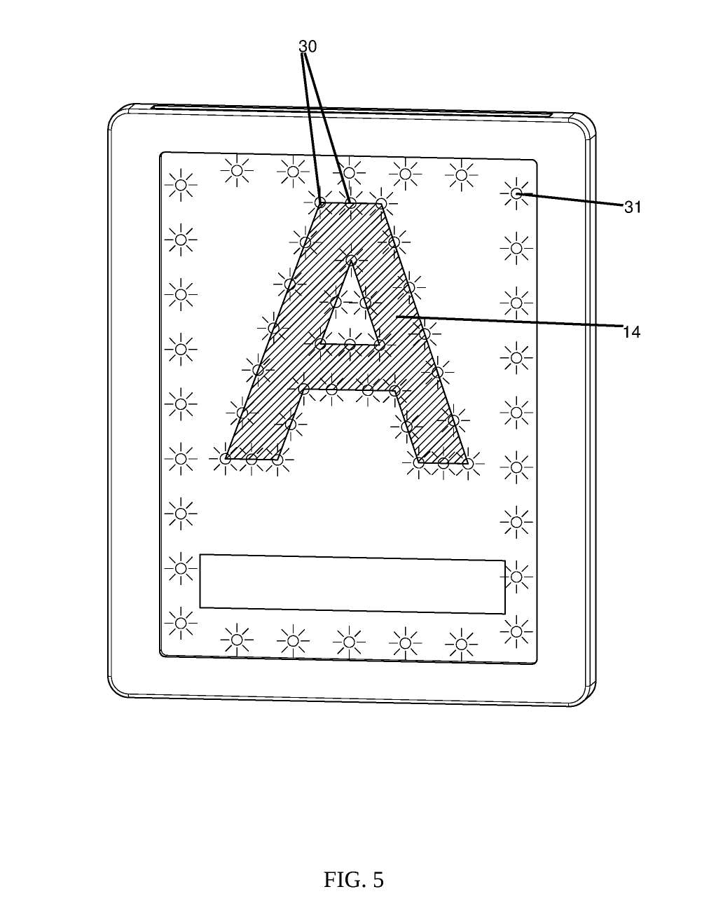

FIG. 5 shows a version of the devices of FIG. 4, with additional illuminated lights around the edges thereof, in an embodiment of the disclosed technology. Here, additional lights 31 are placed around the perimeter of the plate, further illuminating the sign.

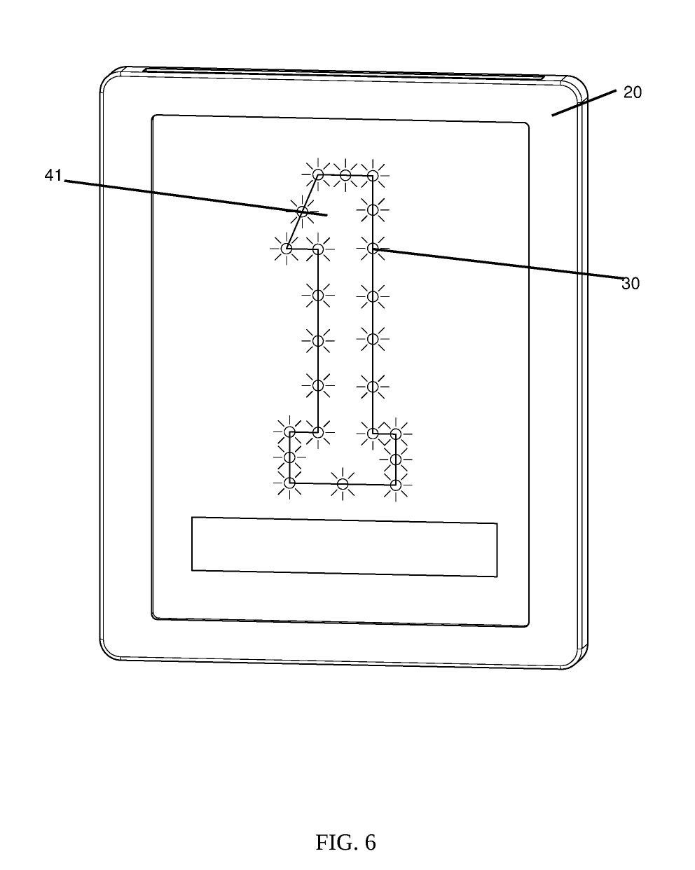

FIG. 6 shows a different sign inserted into a frame and aligned with lights of an embodiment of the disclosed technology. In this case, the indicia or character 41 is the number “1.:. Again, the lights 30 are placed around the outline of the indicia. The indicia can be printed in ink which is flat or raised off the surface of the paper. By placing a plurality of lights on each side of the character, the character is discernible by the lights. The lights further highlight and distinguish the text below from the surroundings of the paper. In this case, the number “1” is highlighted and stands out from the rest of the document being framed.

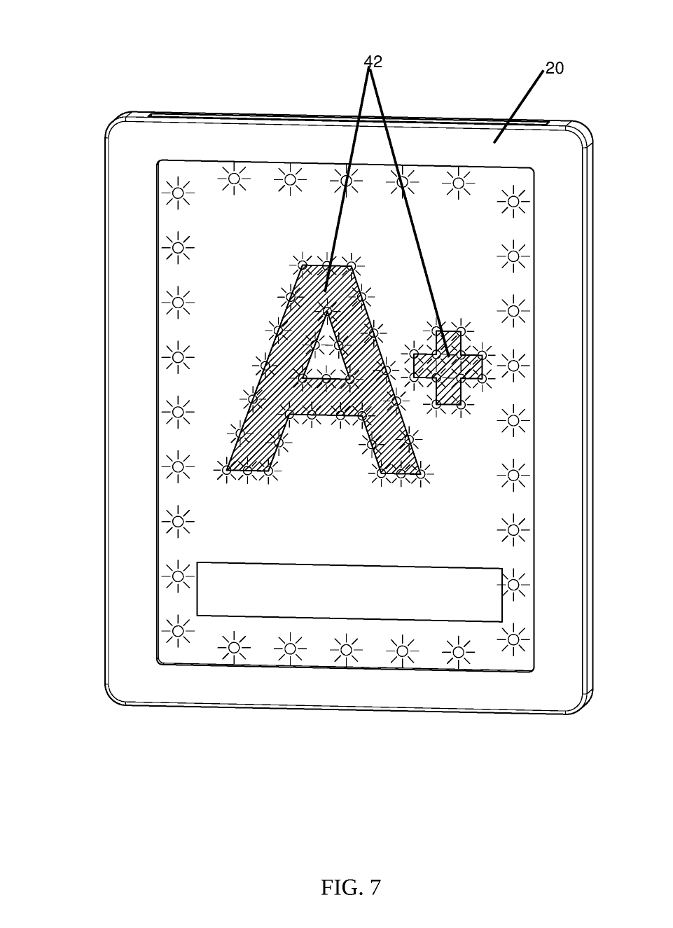

FIG. 7 shows yet another such sign inserted into a frame and aligned with lights, of an embodiment of the disclosed technology. Here the character 42 actually comprises two different characters therein, an “A” and a “+” (plus). Each one has associated lights over the outline, so as not to obscure the symbols beneath, but to highlight them. In the case of the plus symbol, the lights are shown two on each side. with one of the two being at a corner. In embodiments, the corners of the symbol being highlighted by the lights has a light, as does at least one other point along a side extending from the corner, at a minimum.

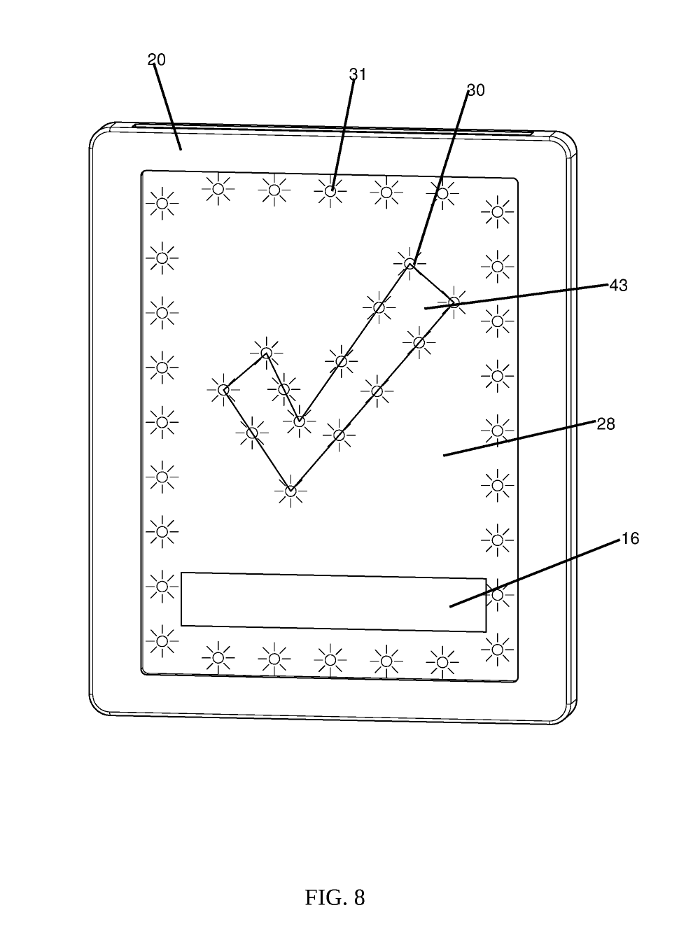

FIG. 8 shows yet another such sign inserted into a frame and aligned with lights, of an embodiment of the disclosed technology. The character 43 is a check mark in this case with, again, a light 30 at each corner and at least one additional light on a side extending from/to each respective corner. For longer sides, more lights are placed there-on in order to make the position of such sides more clear and differentiate them from the shorter sides.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods and apparatuses described hereinabove are also contemplated and within the scope of the invention.

1-15. (canceled)

16. A frame, comprising:
a backing surface;
a translucent surface parallel to and spaced apart from the backing surface by a gap;
a perimeter connecting said backing surface and said translucent surface, the perimeter including a slot adapted for inserting a substrate into said gap;
a plurality of electrical light sources, disposed on said translucent surface and arranged so as to form an outline of a character; and
an electromagnetic field passing along said translucent surface and providing power to said plurality of electrical light sources.

17. The frame of claim 16, wherein said translucent surface comprises a surface of a translucent plate, said plate having a thickness of at most 5 mm.

18. The frame of claim 16, wherein said translucent surface comprises a surface of a translucent plate, said plate having a thickness of at most 2 mm.

19. The frame of claim 16, wherein said plurality of electrical light sources comprise translucent light sources, such that an ink image, disposed in said gap, is visible beneath said plurality of electrical light sources.

20. The frame of claim 16, wherein said plurality of electrical light sources comprise LEDs, which are visible through said translucent surface.

21. A frame, comprising:
a backing surface;
a translucent surface parallel to and spaced apart from the backing surface by a gap;
a perimeter connecting said backing surface and said translucent surface, the perimeter including a slot adapted for inserting a substrate into said gap;
a plurality of electrical light sources, disposed on said translucent surface and arranged so as to form an outline of a character; and
a wire mesh network woven into a material forming said translucent surface, wherein each light of said plurality of electrical lights positioned on said translucent surface receives current from said wire mesh network so as to provide power to said light.

22. The frame of claim 21, wherein said translucent surface comprises a surface of a translucent plate, said plate having a thickness of at most 5 mm.

23. The frame of claim 21, wherein said translucent surface comprises a surface of a translucent plate, said plate having a thickness of at most 2 mm.

24. The frame of claim 21, wherein said plurality of electrical light sources comprise translucent light sources, such that an ink image, disposed in said gap, is visible beneath said plurality of electrical light sources.

25. The frame of claim 21, wherein said plurality of electrical light sources comprise LEDs, which are visible through said translucent surface.

26. A kit for framing a substrate with an ink indicia, the kit comprising:
a frame including:
a backing surface;
a translucent surface parallel to and spaced apart from the backing surface by a gap;
a perimeter connecting said backing surface and said translucent surface, the perimeter including a slot adapted for inserting said substrate into said gap; and
a power source provided on an area of said translucent surface, said power source adapted to provide power a plurality of electrical light sources; and
a plurality of electrical light sources, positionable onto said translucent surface and fixable thereon in positions so as to form an outline of said ink indicia,
such that when the surface with the ink indicia is fully inserted into said gap via said slot, said electrical light sources align with an outline of the ink indicia.

27. The kit of claim 26, wherein said power source comprises a wire mesh network woven into a material forming said translucent surface, said wire mesh network adapted to provide current to each light of said plurality of electrical lights when positioned on said translucent surface, so as to provide power to said light.

28. The kit of claim 26, wherein said power source comprises an electromagnetic field passing along said translucent surface and adapted to provide power to said plurality of electrical light sources when disposed on said translucent surface.

29. The frame of claim 26, wherein said translucent surface comprises a surface of a translucent plate, said plate having a thickness of at most 5 mm.

30. The frame of claim 26, wherein said translucent surface comprises a surface of a translucent plate, said plate having a thickness of at most 2 mm.

31. The frame of claim 26, wherein said plurality of electrical light sources comprise translucent light sources, such that when the substrate is disposed in said gap, the ink indicia is visible beneath said plurality of electrical light sources.

32. The frame of claim 26, wherein said plurality of electrical light sources comprise LEDs and are visible through said translucent surface.
